(19) United States
(12) Patent Application Publication
(10) Pub. No.: US 2004/0189006 A1
(43) Pub. Date: Sep. 30, 2004

(54) Torsional resistant metal gasket

(76) Inventor: Johnny E. Jurena, Houston, TX (US)

Correspondence Address: James E. Bradley, BRACEWELL & PATTERSON, LLP, P.O.Box 61389, Houston, TX, 77208-1389, US

(21) Appl. No.: 10/402,407

(22) Filed: Mar. 28, 2003

(51) Int. Cl. F16L 25/00

(52) U.S. Cl. 285/334.2; 285/341

(57) ABSTRACT

A subsea tubular joint has a wellhead connector and a wellhead housing positioned in an end-to-end relation and connected by a clamp or coupling. A metal annular seal is sandwiched between the wellhead connector and the wellhead housing. The seal has a ring portion and a rib portion. The rib portion includes first and second rib surfaces. There is a frictional treatment between the first and second rib surfaces of the metal annular seal and the shoulders of the wellhead connector and the wellhead housing. The frictional treatment can be a set of radial grooves or the result of grit blasting on the connector and housing. The frictional treatment transmits torsional load between the wellhead connector and the wellhead housing

### TECHNICAL FIELD

This invention relates generally to subsea tubular joints, and in particular to a subsea tubular joint containing a tapered seal and adapted to transmit torsional load between tubular members.

### BACKGROUND OF THE INVENTION

The use of tubular joints for connecting adjacent ends of tubular members in subsea oil and gas well systems is well known in the art. An example would be the flowline connection at the sea floor between a wellhead connector and a wellhead housing. The connector and housing are positioned in an end-to-end relation and connected by a clamp or coupling. A metal annular gasket or seal is positioned between the connector and the housing.

During conventional subsea operations, wave and current in the deeper waters can cause torsional forces on the wellhead connector. These torsion forces can interfere with the performance of the annular seal or potentially cause the wellhead connector and wellhead housing to disconnect. There is currently not an effective way of transferring torsional load from one tubular member to the other to avoid these problems.

### SUMMARY OF THE INVENTION

The present invention relates to an improved flowline connection for tubular members in subsea well assemblies. In the invention, a subsea tubular joint includes a wellhead connector and a wellhead housing positioned in an end-to-end relation with a metal annular seal positioned in between. The seal has a ring portion and a rib portion with first and second rib surfaces.

The invention provides a frictional treatment on at least one of the surfaces of a first interface between the first rib surface of the seal and the shoulder surface of the wellhead connector. The invention also provides a frictional treatment on at least one of the surfaces of a second interface between the second rib surface of the seal and the shoulder surface of the wellhead housing.

The purpose of the frictional treatments is to transmit torsional load between the wellhead housing and the wellhead connector. In one preferred embodiment, the frictional treatment is a set of radial grooves or threads on adjacent mating surfaces. In another preferred embodiment, the frictional treatment results from grit blasting at least one of the shoulder surfaces of the wellhead connector and wellhead housing.

### BRIEF DESCRIPTION OF THE DRAWINGS

FIG. 1 shows a sectional side view of a tubular joint constructed in accordance with this invention.

FIG. 2 shows an enlarged sectional side view of engaged radial grooves at the first and second interfaces of the tubular joint.

FIG. 3 shows a top view of a metal annular seal with radial grooves along its rib section.

### DETAILED DESCRIPTION OF THE INVENTION

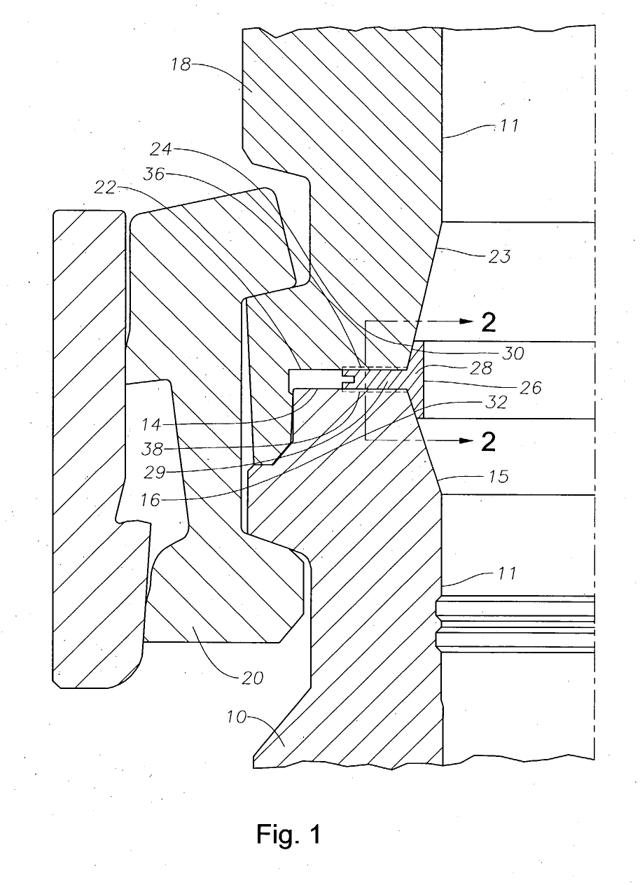

Referring first to FIG. 1, a generally cylindrical subsea wellhead housing 10 extends upward from the sea floor and has a bore 11. Housing 10 has a shoulder surface 14 that is upward facing and generally perpendicular to bore 11. Housing 10 has a tapering surface 15 on its inner diameter extending from shoulder surface 14 downward and inward into bore 11. The upper portion of the tapering surface 15 has a conical primary sealing surface 16.

A wellhead connector 18 is generally axially aligned with the wellhead housing 10 and secured to the wellhead housing by a clamp 20. The wellhead connector 18 has a shoulder surface 22 that is downward facing and generally perpendicular to bore 11. Connector 18 has a tapering surface 23 on its inner diameter extending from shoulder surface 22 upward and inward into bore 11. The lower portion of the tapering surface 23 has a conical primary sealing surface 24.

A metal annular seal 26 is adapted to seal against primary sealing surfaces 16 and 24 and fit between wellhead shoulder surface 14 and connector shoulder surface 22. Seal 26 has a ring portion 28 and a rib portion 29. In FIG. 1, ring portion 28 and rib portion 29 are joined together as one unit. However, ring portion 28 and rib portion 29 can also be separated into two or more individual units.

The ring portion 28 of the seal 26 has an upper tapered seal surface 30 and a lower tapered seal surface 32 on its outer diameter. Upper and lower tapered surfaces 30 and 32 each have approximately the same slope as primary seal surfaces 24 and 16, respectively. The diameter of seal ring 26 is such that tapered seal surfaces 30 and 32 interferingly engage primary sealing surfaces 16 and 24 when seal 26 is sandwiched between wellhead housing 10 and connector 18, and connector 18 is landed upon wellhead housing 10. There is elastic deformation of tapered seal 26 between the tapered seal surfaces 30 and 32 and the primary sealing surfaces 16 and 24 when connector 18 is landed on wellhead housing 10 and seals annular seal 26 to connector 18 and housing 10.

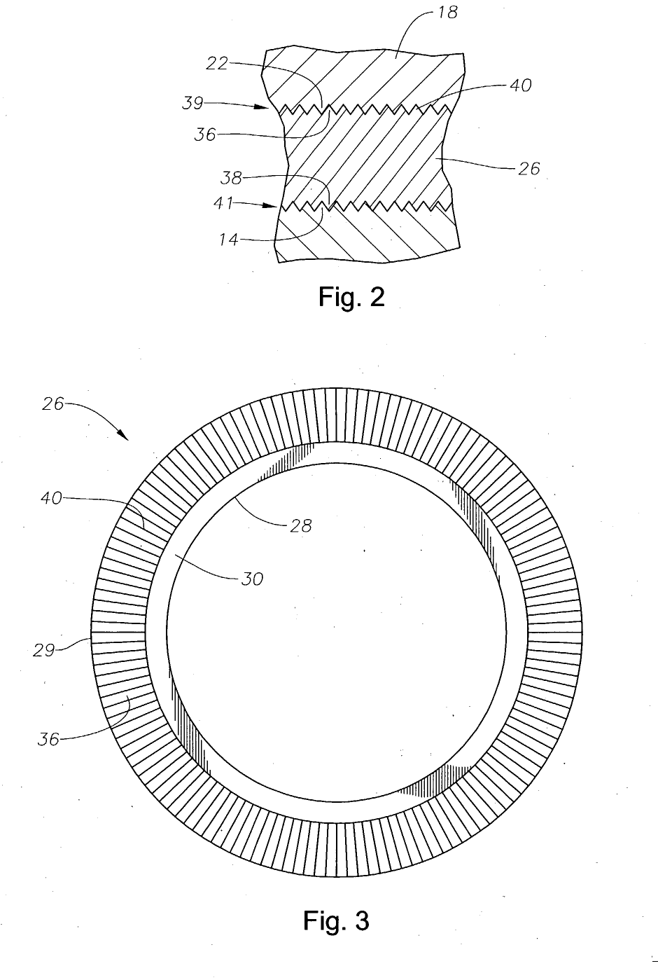

The rib portion 29 of the seal 26 extends radially outward from ring portion 28. The rib portion 29 has a first rib surface 36 and a second rib surface 38 on opposite sides of the rib. The first and second rib surfaces 36 and 38 are generally parallel with wellhead shoulder surface 14 and connector shoulder surface 22. Rib portion 29 is sized to fit in between wellhead shoulder surface 14 and connector shoulder surface 22, but does not form a seal. There is a first interface 39 (see FIG. 2) between the first rib surface 36 and the connector shoulder surface 22. There is a second interface 41 (see FIG. 2) between the second rib surface 38 and the wellhead shoulder 14. Connector 18 is landed on wellhead housing 10 and seals annular seal 26 to connector 18 and housing 10 at first and second interfaces 39 and 41. Seal 26 contains internal pressure within wellhead housing 10 and connector 18.

At least one surface from the first interface 39 and at least one surface from the second interface 41 has a frictional treatment for the purpose of transmitting torsional load between the wellhead housing 10 and the wellhead connector 18. In the preferred embodiment shown in FIG. 2, the frictional treatment is a set of radial grooves 40 on adjacent mating surfaces. The complementary, adjacent radial grooves of the first interface 39 and of the second interface 41 are aligned such that they will engage each other, thus transmitting torsional load between the surfaces. In another embodiment (not shown), the frictional treatment results from grit blasting either one or both of the shoulder surfaces 14 and 22, such that the grit blasted surface will bite into the adjacent first rib surface 36 and/or second rib surface 38 of the seal 26, thus transferring torsional load.

FIG. 3 presents a top view of the metal annular seal 26 With ring portion 28 and rib portion 29 joined together as one unit, showing the upper tapered surface 30 of the ring portion 28 nearest the inner diameter of the annular seal 26, and the first rib surface 36 of the rib portion 29 nearest the outer diameter of the annular seal 26. The radial grooves 40 are shown along the first rib surface 36, forming a circular array. Also, each groove 40 extends from ring portion 28 to the outer diameter of rib portion 29.

The frictional treatment in the current invention provides an advantage over the prior art, in that it allows for efficient transfer of torsional load between the wellhead housing and the wellhead connector.

Though the invention is discussed in the context of a subsea wellhead housing and a wellhead connector, it would be clear to one skilled in the art that this invention is applicable to virtually any tubular joint connection employing a tapered seal, for example the juncture of two hubs. Additionally, while the invention has been shown in only one of its forms, it should be apparent to those skilled in the art that it is not so limited, but is susceptible to various changes without departing from the scope of the invention.

What is claimed is:

1. A tubular joint comprising:
a first tubular member having a bore and a shoulder surface generally perpendicular to the bore;
a second tubular member having a bore and a shoulder surface generally perpendicular to the bore, the second tubular member connected with the first tubular member in an end-to-end orientation;
an annular rib sandwiched between the shoulder surfaces, defining a first interface between a first surface of the rib and the shoulder surface of the first tubular member and a second interface between a second surface of the rib and the shoulder surface of the second tubular member; and
at least one of the surfaces of the first interface and one of the surfaces of the second interface having a frictional treatment to transmit torsional load from one tubular member to the other.

2. The tubular joint of claim 1, wherein the frictional treatment comprises a set of radial grooves.

3. The tubular joint of claim 1, wherein the frictional treatment is located on both the first and second surfaces of the rib.

4. The tubular joint of claim 1, wherein the frictional treatment is located on the shoulder surfaces of the first and second tubular members.

5. The tubular joint of claim 1, wherein the frictional treatment is located on both the first and second surfaces of the rib and on the shoulder surfaces of the first and second tubular members.

6. The tubular joint of claim 1, wherein the frictional treatment comprises a set of radial grooves located on both the first and second surfaces of the rib.

7. The tubular joint of claim 1, wherein the frictional treatment comprises a set of radial grooves located on the shoulder surfaces of the first and second tubular members.

8. The tubular joint of claim 1, wherein the frictional treatment comprises a set of radial grooves located on both the first and second surfaces of the rib and on the shoulder surfaces of the first and second tubular members.

9. The tubular joint of claim 1, further comprising:
a tapered inner end surface on the first tubular member;
a tapered inner end surface on the second tubular member;
a metal annular seal joined to and extending inward from the annular rib;
a first tapered sealing surface on the annular seal that sealingly engages the tapered inner end surface of the first tubular member; and
a second tapered sealing surface on the annular seal that sealingly engages the tapered end surface of the second tubular member.

10. A tubular joint comprising:
a first tubular member having a bore, a tapered inner end surface, and a shoulder surface generally perpendicular to the bore;
a second tubular member having a bore, a tapered inner end surface, and a shoulder surface generally perpendicular to the bore, the second tubular member connected with the first tubular member in an end-to-end orientation;
a metal annular seal positioned between the tubular members;
a first tapered sealing surface on the annular seal that sealingly engages the tapered inner end surface of the first tubular member;
a second tapered sealing surface on the annular seal that sealingly engages the tapered end surface of the second tubular member;
an annular rib extending radially outward from the sealing surfaces and sandwiched between the shoulder surfaces, having a first surface of the rib that mates with the shoulder surface of the first tubular member and a second surface that mates with the shoulder surface of the second tubular member; and
the first surface of the rib and the second surface of the rib each having a set of radial grooves to transmit torsional load from one tubular member to the other.

11. The tubular joint of claim 9, wherein a set of radial grooves is located on each of the shoulder surfaces of the first and second tubular members.

12. The tubular joint of claim 9, wherein the radial grooves form a circular array around the rib.

13. A method of connecting tubular members, each of the tubular members having a bore, a tapered inner end surface, and a shoulder surface generally perpendicular to the bore, the method comprising:
providing a metal annular seal having first and second tapered sealing surfaces, and an annular rib extending radially outward from the sealing surfaces;
providing frictional treatments on the first and second surfaces of the rib;
sandwiching the rib between the shoulder surfaces of the first tubular member and the second tubular member and engaging the tapered sealing surfaces with the tapered end surfaces; and
transmitting torsional load from one tubular member to the other.
